(19) United States
(12) Patent Application Publication
(10) Pub. No.: US 2025/0335238 A1
(43) Pub. Date: Oct. 30, 2025

(54) INTERRUPT MESSAGING TECHNOLOGIES

(71) Applicant: Intel Corporation, Santa Clara, CA (US)

(72) Inventors: Sarathy JAYAKUMAR, Portland, OR (US); Shubhada PUGAONKAR, Portland, OR (US); Smitha BANAVIKAL MATH VEERABHADRESH, Bengaluru (IN); Theodros YIGZAW, Sherwood, OR (US); Samuel HO, Framingham, MA (US); Puneet APPANA SRINIVASA VISWARAMA, Hyderabad (IN); Rahul SHAH, Marlborough, MA (US); Shashikanth N V, Bangalore (IN)

(21) Appl. No.: 19/263,235

(22) Filed: Jul. 8, 2025

(51) Int. Cl. G06F 9/48; G06F 11/07

(52) U.S. Cl. CPC G06F 9/4831; G06F 11/0745; G06F 11/0769

(57) ABSTRACT

Examples described herein relate to an interface and a circuitry, coupled to the interface. In some examples, the circuitry is to translate an interrupt from system management interrupt (SMI) format to a second interrupt in System Control Interrupt (SCI) format and transmit the second interrupt, by the interface, to an SCI interrupt handler to perform event handling. In some examples, the SCI interrupt handler is to execute on a single thread.

In a computer system, an interrupt request (IRQ) is a signal sent to a processor that halts a program and allows an interrupt handler to run. Hardware interrupts are used to handle events such as processing packets or data from a network interface, responding to inputs from peripheral interfaces (e.g., keyboard, mouse, or touch screen), and so forth. System Management Interrupt (SMI) is a hardware interrupt that is used to invoke System Management Mode (SMM) for runtime error handling. SMM provides reliability, availability, serviceability (RAS) flows, providing capability to run differentiation code, manage warranties, and provide out-of-band error visibility. SMM mode halts all the cores on a system.

### BRIEF DESCRIPTION OF THE DRAWINGS

FIG. 1 depicts an example system.

FIG. 2 depicts an example system.

FIG. 3 depicts an example of event conversion.

FIG. 4 depicts an example of operations.

FIG. 5A depicts an example process.

FIG. 5B depicts an example process.

FIG. 6 depicts an example computing system.

### DETAILED DESCRIPTION

Based on a source of an interrupt or error, various examples can convert an SMI interrupt into a System Control Interrupt (SCI) type for handling by an SCI interrupt handler or transfer a received interrupt to an associated interrupt handler. An SCI can directly invoke an SCI interrupt handler that can execute on a single thread. The SCI interrupt handler can utilize Ring 0 privileges, which provide operating system (OS) privilege level access to system resources (e.g., registers that store basis for an error or interrupt and source of error or interrupt). Accordingly, execution of the SCI interrupt handler may not impact execution of other threads on a processor that executes the single thread. By contrast, when the SMM runs in a special reserved memory, SMM may execute on multiple threads and can stall multiple threads. Instead of interrupting and halting multiple threads due to SMI, SCI can interrupt merely a single thread. Moreover, existing SMI interrupt generator hardware and software can continue to be utilized. Some examples utilize a data (e.g., bitmap) that indicates whether to convert an error message or interrupt type per interrupt source. Based on an issuer of the interrupt, the data can indicate to remap an interrupt to SCI or remain SMI or other type.

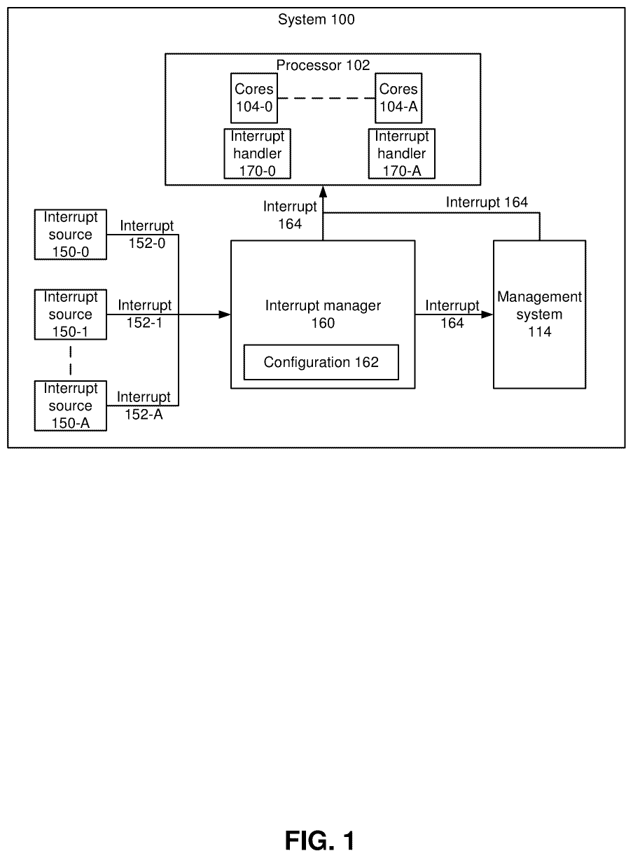

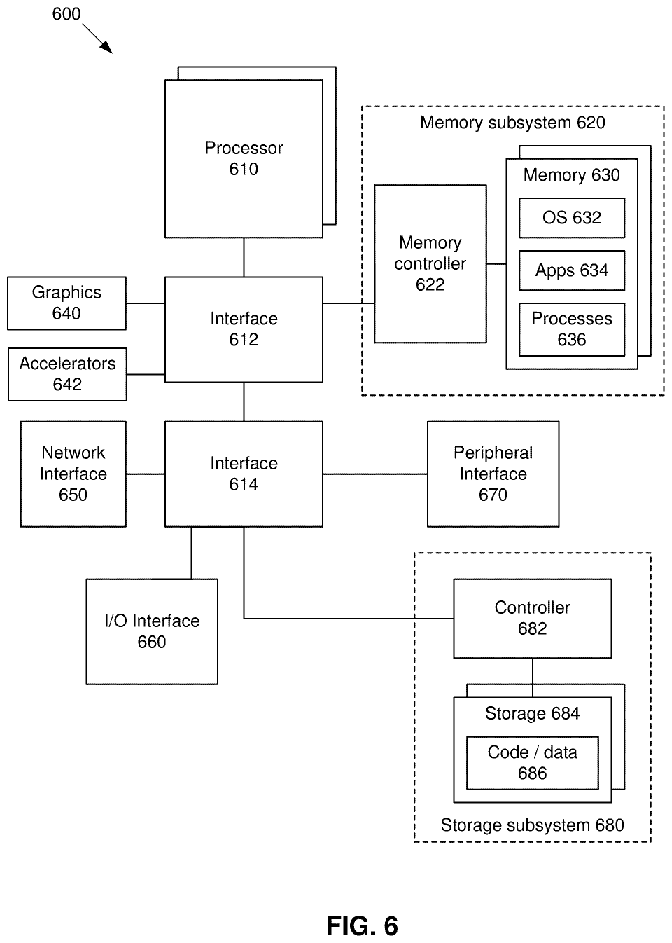

FIG. 1 depicts an example system. For example, system 100 can be implemented as a system on chip (SoC) or one or more tiles. An SoC can include an integrated circuit that includes one or more of: one or more processors, memory interface, input/output (I/O) circuitry, storage interface, network interface, and other circuitry. A tile can include one or more processors and I/O circuitry formed in an SoC or connected by a circuit board. Various examples of circuitry and software that can be utilized by system 100 are described at least with respect to FIG. 6.

Processor 102 can include one or more cores 104-0 to 104-A, where A is an integer. One or more of cores 104-0 to 104-A can include an execution core or computational engine that is capable of executing instructions. One or more cores 104-0 to 104-A can access to its own cache and read only memory (ROM), or multiple cores can share a cache or ROM. One or more of cores 104-0 to 104-A can be homogeneous (e.g., same processing capabilities) and/or heterogeneous devices (e.g., different processing capabilities). One or more of cores 104-0 to 104-A can be sold or designed by Intel®, Advanced RISC Machines (ARM)®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

One or more of cores 104-0 to 104-A can utilize a system agent or uncore circuitry (not shown) that can include or more of a memory controller, a cache coherency manager, arithmetic logic units, floating point units, core or processor interconnects, Caching/Home Agent (CHA), interface circuitry (e.g., fabric, memory, device), bus or link controllers (e.g., Advanced Microcontroller Bus Architecture (AMBA) capabilities), direct memory access (DMA) engine, or others. One or more of cores 104-0 to 104-A can access cache and read only memory (ROM), or multiple cores can share a cache or ROM.

System 100 or processor 102 can include interrupt manager 160. Interrupt manager 160 can receive error or interrupt messages from various circuitries of system 100. Interrupt manager 160 can access a remap register from configuration 162 that can include a bitmap that indicates whether to remap an error or interrupt based on a source of an error message (e.g., interrupt source 150-0 to 150-A, where A is an integer). Interrupt manager 160 can access configuration 162 in a register or memory to check if the source identifier (ID) of the issuer of the error matches sources specified in configuration 162. If a remap SCI bit for the given source is set in a register, then interrupt manager 160 can generate an SCI for the interrupt to one or more of interrupt handlers 170-0 to 170-A, executed by one or more cores. If the remap SCI bit is not set for the given source, interrupt manager 160 can generate an interrupt to one or more of interrupt handlers 170-0 to 170-A as configured (e.g., SMI, Non-Maskable Interrupt (NMI), error pin (ERR #), input output machine check architecture (IOMCA (e.g., MCA via Peripheral Component Interconnect express (PCIe)), or others). In some examples, the interrupt path (e.g., assert_smi) can be remapped per-source from SMI to SCI, while the error path can be mapped per-severity to one of SCI, SMI, NMI, machine check aborts, corrected machine check interrupt (CMCI), message signaled interrupt (MSI), or others. Errors such as PCIE_ERR, PCIE_AER, DO_SERR can generate SMI, NMI, or SCI based on register contents based on configuration 162. However, the error messages can also generate SMI. In some examples, only the PCH_EVENT and ASSERT_SMI can be re-mapped to SCI through a remap register from configuration 162.

Errors and interrupts can include at least SMI errors, platform (e.g., platform control hub (PCH)) events, device interface errors, MCA messages, correctable error messages, pin error messages, or others. For example, some interrupts are described at least in Chapter 6 of Intel® 64 and IA-32 Architectures Software Developer's Manual, Volume 3 System Programming Guide (March 2025), and earlier versions and variations thereof.

For some device interface errors (e.g., PCIe errors), interrupt manager 160 can determine whether the device interface error is fatal, non-fatal, or correctable in a manner consistent at least with PCI Express 1.0 Specification (2003) and variations and derivatives thereof. Depending on whether the device interface error is fatal, non-fatal, or correctable, the following Table 1 indicates an example configuration 162 to indicate how interrupt manager 160 is to signal an error (e.g., SCI, NMI, SMI, or no system event generation) to one or more of interrupt handlers 170-0 to 170-A.

TABLE 1

| | |
|---|---|
| Fatal | 11: Generate SCI |
| | 10: Generate NMI |
| | 01: Generate SMI |
| | 00: No system event generation |
| Non-Fatal | 11: Generate SCI |
| | 10: Generate NMI |
| | 01 Generate SMI |
| | 00: No system event generation |
| Correctable | 11: Generate SCI |
| | 10: Generate NMI |
| | 01: Generate SMI |
| | 00: No system event generation |

For example, based on configuration 162, for Machine Check Architecture (MCA) error reporting, interrupt manager 160 can convert MCA related errors to SCI to report to one or more of interrupt handlers 170-0 to 170-A. MCA related errors can include errors arising from storage access, such as Correctable System Management Interrupt (CSMI). When a field in configuration 162 is set, a CSMI can cause interrupt manager 160 to generate an SCI. Interrupt manager 160 can identify, to one or more of interrupt handlers 170-0 to 170-A, an MCA bank that generated the SCI by writing to a register. An MCA bank can store information about an error and is defined in the Intel® 64 and IA-32 Architecture Software Developer's Manual, Volume 3A, Chapter 17 (2025), earlier versions, later versions, and variations thereof.

For example, based on configuration 162, for IO error reporting, interrupt manager 160 can identify a port identifier (ID) of the device reporting an error and identify an error status register, corresponding to fatal, non-fatal, and correctable severities to one or more of interrupt handlers 170-0 to 170-A. For different severity levels (e.g., fatal, non-fatal, correctable), interrupt manager 160 can signal IO domain errors as SCI, SMI, Non-Maskable Interrupt (NMI), or other manners.

For example, based on configuration 162, for direct SMI or platform error reporting, interrupt manager 160 can convert SMI or circuit board (e.g., Platform Controller Hub (PCH)) events to SCI to report to one or more of interrupt handlers 170-0 to 170-A.

For example, based on configuration 162, for Core Building Block (CBB) error reporting, interrupt manager 160 can convert CSMI to SCI to report to one or more of interrupt handlers 170-0 to 170-A.

Table 2 depicts an example of register values for configuration and assertion status.

TABLE 2

| | Example | |
|---|---|---|
| Configuration in register(s) | Width | Example usage |
| REG_REMAP_UCSMI_CTL | 32 | Enable correctable SMI (CSMI) to SCI per |
| | | MCA bank |
| | | 1: CSMI converted to SCI |
| | | 0: CSMI reports as SMI |
| REG_REMAP_USCI_STATUS | 32 | SCI remap status record can indicate a |
| | | conversion has occurred |
| UNCORE_SMI_ERR_SRC_STATUS | 32 | SMI status record to identify of source of |
| | | SMI, regardless of whether conversion has |
| | | occurred |
| GLOBAL_AGENT_SRCID_{01 . . . 63} | 64 | Port identifiers (IDs) of source (agents) |
| | | sending interrupt messages (e.g., PCIe, |
| | | PCH_Event, and SMI messages) that |
| | | identifies a bit location in |
| | | REG_REMAP_SMI_CTL that indicates |
| | | whether to convert interrupt to SCI or leave |
| | | as SCI |
| REG_REMAP_SMI_CTL | 64 | Enable remapping for each reporting agent |
| | | (yes or no) |
| REG_REMAP_SCI_STATUS | 64 | Non-correctable SCI Remap status record |
| | | for each reporting agent to indicate that the |
| | | remap from SMI to SCI occurred |
| REG_REMAP_SMI_STATUS | 64 | SMI status record for each reporting agent |
| | | to indicate that no remap occurred |

Interrupt manager 160 can report interrupts and errors via a bus to an interrupt handler executed by processor 102. In some examples, interrupt manager 160 can report interrupts and errors to management system 114 (e.g., Secured Startup Services Module (S3M)) that provides a consolidated hardware and firmware infrastructure that runs firmware enabling platform security, reliability, and configurability services. Management system 114 can report interrupts and errors to one or more of interrupt handlers 170-0 to 170-A executed by processor 102.

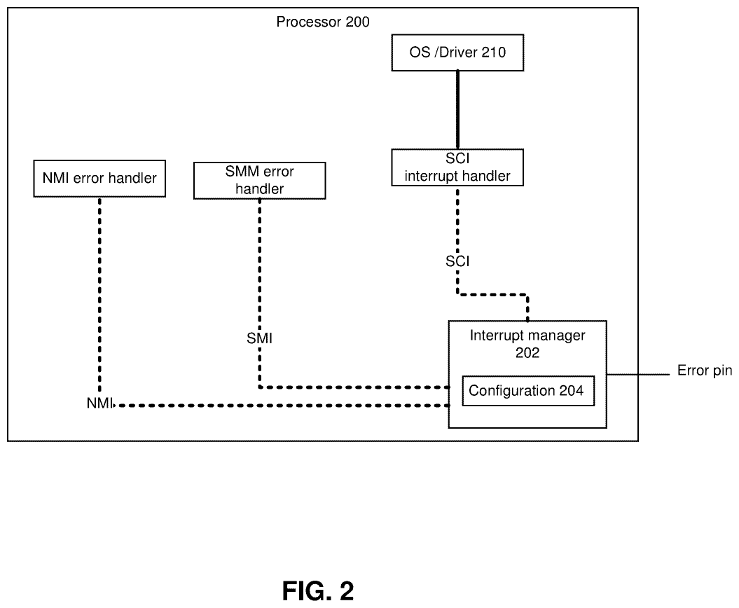

FIG. 2 depicts an example system. Interrupt manager 202 can receive interrupts in various formats including SCI, NMI, error pin, MCA, SMI, or others. Based on configuration 204, interrupt manager 202 can convert interrupts to SCI or retain the format or type of the interrupt. Based on the interrupt type, interrupt manager 202 can invoke an associated type of interrupt handler (e.g., NMI error handler, SMM error handler, SCI interrupt handler, or others). In some examples, SCI interrupt handler can execute on a single thread and can execute as Ring 0 software. A thread can include a sequence of instructions that a processor can execute independently, such as for multitasking.

In some examples, SCI interrupt handler can be built into boot firmware (e.g., BIOS or UEFI). In some embodiments, boot firmware code can be one or more of: Basic Input/Output System (BIOS), Universal Extensible Firmware Interface (UEFI), or a boot loader. The BIOS firmware can be pre-installed on a personal computer's system board or accessible through an SPI interface from a boot storage (e.g., flash memory). In some examples, a BIOS can be stored on a device and accessible from the device by one or more cores or CPUs using an interface such as Serial Peripheral Interface (SPI) or other interface (e.g., PCIe). BIOS can initialize and test the system hardware components and loads a boot loader from a memory device which initializes and executes an operating system (OS). The OS, in some examples can be Linux®, Windows®, FreeBSD®, Android®, MacOS®, iOS®, or any other operating system. The OS and driver can execute on a CPU sold or designed by Intel®, ARM®, AMD®, Qualcomm®, IBM®, Texas Instruments®, among others.

In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

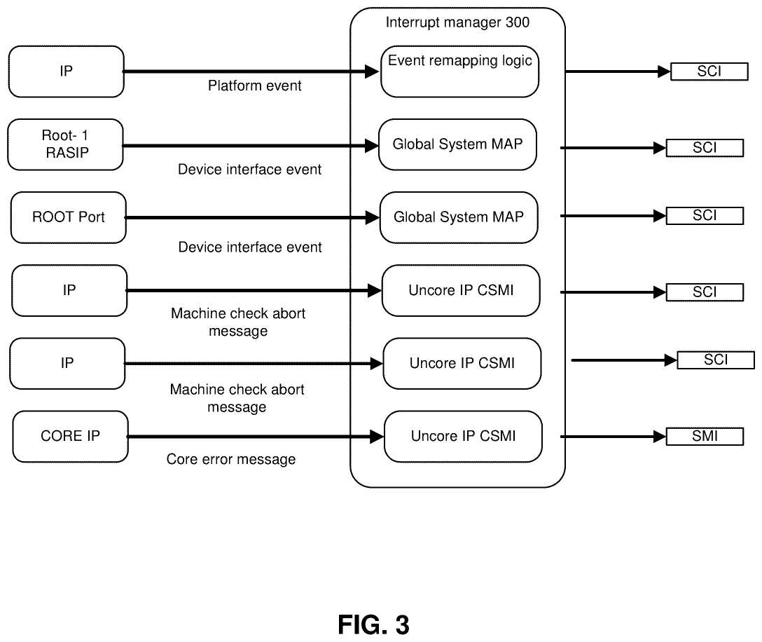

FIG. 3 depicts an example of event conversion. Interrupt manager 300 can map certain errors to generate SCI or retain their type based at least on a source of an error, as described herein. For example, platform event (e.g., PCH_Event) can indicate platform control hub (PCH) error events, such as circuit board errors. For example, device interface error (e.g., PCIe error message) can indicate a host interface error. For example, machine check abort (MCA) Message can indicate processor error or machine check message. For example, core error message (e.g., RAS_NCU_MSG) can indicate an error message from a core.

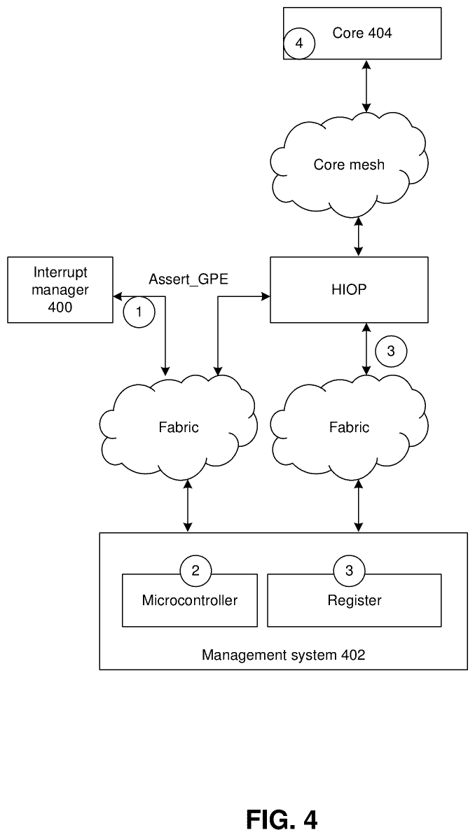

FIG. 4 depicts an example of operations. At (1), interrupt manager 400 can collect errors and interrupts from sources and send errors and interrupts via general purpose side band (GPSB) connection to management system 402. At (2), a microcontroller of management system 402 can execute firmware that writes a general purpose event status to a register to indicate a source of the error or interrupt. At (3), the microcontroller can issue a memory write to a specific memory mapped location via primary scalable fabric (PSF). Host IO processor (HIOP) registers can connect PSF and core mesh.

At (4), interrupt controller of core 404 reads a specific memory mapped location associated with the interrupt and interrupts core 404. Core 404 invokes a software handler based on interrupt vector handler to perform error handling. On receiving the interrupt, the software handler reviews status bits to determine the interrupt and source and performs error handling methods associated with the source of the interrupt. Error handling can include execution of code segments to handle interrupt events by performing corrective actions, issuing an error indication to a system administrator, prioritizing interrupt handling, interrupt masking, interrupt acknowledgement, or others.

Interrupt coalescing can be used to batch handling of any type of corrective actions together, after multiple faults occur, limiting the number of kernel thread activations to handle interrupts. For example, kernel thread activations can be used by any operating system including Linux®, Microsoft Windows®, Android®, iOS®, MacOS®, and so forth. Type and time threshold adjustment options can be used to fine tune the steering or coalescing options.

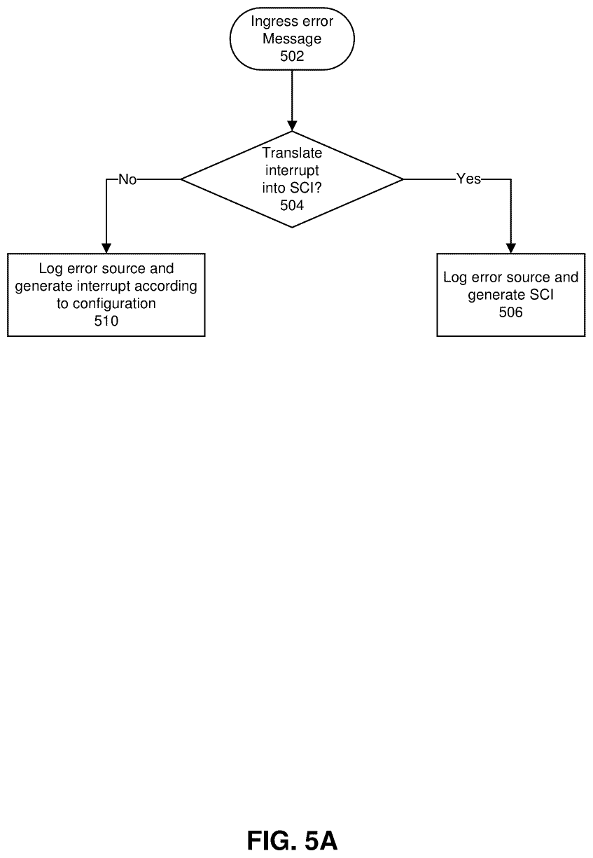

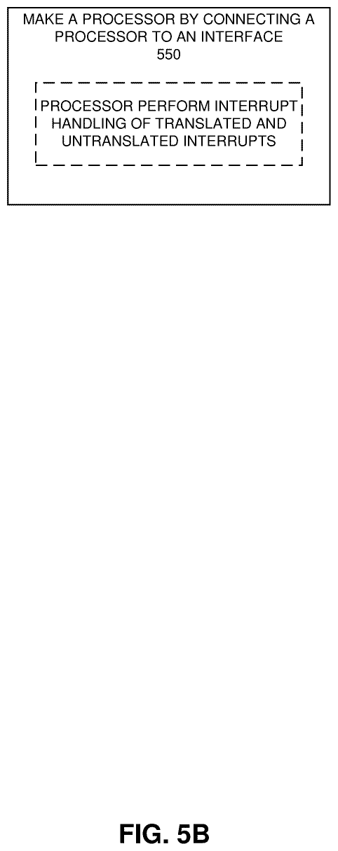

FIG. 5A depicts an example process to generate an interrupt. At 502, an interrupt or error message can be received. The interrupt or error message can be received from a particular source device such as device interface, interconnect, network interface device, accelerator, processor, or other circuitry, firmware, or software. At 504, a determination can be made as to whether to translate the interrupt or error message or provide the interrupt or error message with or without translation to an associated interrupt handler. Based on a determination to translate the message to SCI, at 506, an SCI can be issued to an interrupt handler. An interrupt handler can perform error handling based on a source of the SCI. Based on a determination to not translate the interrupt or error message, the interrupt or error message can be issued to a corresponding interrupt handler. For example, an SMI can be issued, with or without translation or conversion, to an SMI interrupt handler, an NMI can be issued, with or without translation or conversion, to an NMI interrupt handler, and so forth.

FIG. 5B depicts an example process to make a processor. At 550, a processor can be connected to an interface. The interface can receive an interrupt that is translated or untranslated. The processor can execute an interrupt handler that performs interrupt handling based on a type of interrupt. Various types of interrupt include SCI, SMI, NMI, or others.

FIG. 6 depicts a system. In some examples, a processor (e.g., processor 610, graphics 640, or network interface 650) can perform interrupt translation and interrupt handling based on a configuration, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 610 can include multiple processors and multiple processors can be embodied as processor sockets.

In one example, system 600 includes interface 612 coupled to processor 610, which can represent a higher speed interface or a high throughput interface for system components, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. For example, accelerators 642 can include a load balancer accelerator or circuitry. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers, workstations, or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes an apparatus that includes: an interface and a circuitry, coupled to the interface, the circuitry to translate an interrupt from system management interrupt (SMI) format to a second interrupt in System Control Interrupt (SCI) format and transmit the second interrupt, by the interface, to an SCI interrupt handler to perform event handling.

Example 2 includes one or more examples, wherein the SCI interrupt handler is to execute on a single thread.

Example 3 includes one or more examples, wherein the SCI interrupt handler has operating system (OS) privilege level access to registers that identify error information.

Example 4 includes one or more examples, wherein the circuitry is to access a configuration to determine to translate the interrupt from SMI format to the second interrupt in SCI format.

Example 5 includes one or more examples, wherein the circuitry is to access the configuration to determine to not translate the interrupt from SMI into the second interrupt in SCI format.

Example 6 includes one or more examples, wherein the circuitry is to: receive a third interrupt, access the configuration to determine whether translate the third interrupt into SCI format, and based on a determination to not translate the third interrupt to SCI format, provide the third interrupt to a corresponding interrupt handler.

Example 7 includes one or more examples, wherein the third interrupt comprises a format of: SCI, SMI, Non-Maskable Interrupt (NMI), machine check aborts, corrected machine check interrupt (CMCI), or message signaled interrupt (MSI).

Example 8 includes one or more examples, wherein the event handling comprises performance of error correction or identification of an uncorrectable error.

Example 9 includes one or more examples, wherein the interrupt comprises at least one of: a platform error, an input/output (I/O) error, a host interface error, or a processor error.

Example 10 includes one or more examples, and includes a system on chip (SoC), wherein the SoC comprises the interface and the circuitry and one or more devices to provide interrupts to the circuitry.

Example 11 includes one or more examples, and includes a process for making a processor comprising: connecting a processor and a memory, wherein: the processor accesses a bitmap from the memory and based on the bitmap, determines whether to translate a format of a first interrupt into a second format or provide the first interrupt without change in format to an interrupt handler.

Example 12 includes one or more examples, wherein the translate the format of a first interrupt into a second format comprises: translating the first interrupt from system management interrupt (SMI) format to System Control Interrupt (SCI) format and transmitting the second interrupt to an SCI interrupt handler to perform event handling.

Example 13 includes one or more examples, wherein the bitmap indicates a source of the first interrupt and wherein the determination to translate the format of the first interrupt into the second format is based on the source of the first interrupt.

Example 14 includes one or more examples, wherein the interrupt handler comprises a System Control Interrupt (SCI) interrupt handler and wherein the SCI interrupt handler has operating system (OS) privilege level access to memory and circuitry.

Example 15 includes one or more examples, wherein a format of the first interrupt comprises: System Control Interrupt (SCI), System Management Interrupt (SMI), or Non-Maskable Interrupt (NMI).

Example 16 includes one or more examples, and includes at least one non-transitory computer-readable medium comprising instructions stored thereon, that when executed by one or more processors, cause the one or more processors to: execute a first interrupt handler that is to process a first interrupt, wherein the first interrupt is a translation of a second interrupt from System Management Interrupt (SMI) format to System Control Interrupt (SCI) format and execute a second interrupt handler that is to process a third interrupt, wherein the third interrupt comprises a version of a source interrupt.

Example 17 includes one or more examples, wherein the first interrupt handler is to execute on a single thread.

Example 18 includes one or more examples, wherein the first interrupt handler comprises an SCI interrupt handler and has operating system (OS) privilege level access to memory and circuitry.

Example 19 includes one or more examples, wherein the translation of the first interrupt is based on a configuration.

Example 20 includes one or more examples, wherein the third interrupt comprises a format of: SCI, SMI, or Non-Maskable Interrupt (NMI).

1. An apparatus comprising:
an interface and
a circuitry, coupled to the interface, the circuitry to translate an interrupt from system management interrupt (SMI) format to a second interrupt in System Control Interrupt (SCI) format and transmit the second interrupt, by the interface, to an SCI interrupt handler to perform event handling.

2. The apparatus of claim 1, wherein the SCI interrupt handler is to execute on a single thread.

3. The apparatus of claim 1, wherein the SCI interrupt handler has operating system (OS) privilege level access to registers that identify error information.

4. The apparatus of claim 1, wherein the circuitry is to access a configuration to determine to translate the interrupt from SMI format to the second interrupt in SCI format.

5. The apparatus of claim 4, wherein the circuitry is to access the configuration to determine to not translate the interrupt from SMI into the second interrupt in SCI format.

6. The apparatus of claim 4, wherein the circuitry is to:
receive a third interrupt,
access the configuration to determine whether translate the third interrupt into SCI format, and
based on a determination to not translate the third interrupt to SCI format, provide the third interrupt to a corresponding interrupt handler.

7. The apparatus of claim 6, wherein the third interrupt comprises a format of: SCI, SMI, Non-Maskable Interrupt (NMI), machine check aborts, corrected machine check interrupt (CMCI), or message signaled interrupt (MSI).

8. The apparatus of claim 1, wherein the event handling comprises performance of error correction or identification of an uncorrectable error.

9. The apparatus of claim 1, wherein the interrupt comprises at least one of: a platform error, an input/output (I/O) error, a host interface error, or a processor error.

10. The apparatus of claim 1, comprising a system on chip (SoC), wherein the SoC comprises the interface and the circuitry and one or more devices to provide interrupts to the circuitry.

11. A process for making a processor comprising:
connecting a processor and a memory, wherein:
the processor accesses a bitmap from the memory and based on the bitmap, determines whether to translate a format of a first interrupt into a second format or provide the first interrupt without change in format to an interrupt handler.

12. The process of claim 11, wherein the translate the format of a first interrupt into a second format comprises:
translating the first interrupt from system management interrupt (SMI) format to System Control Interrupt (SCI) format and transmitting the second interrupt to an SCI interrupt handler to perform event handling.

13. The process of claim 11, wherein the bitmap indicates a source of the first interrupt and wherein the determination to translate the format of the first interrupt into the second format is based on the source of the first interrupt.

14. The process of claim 11, wherein the interrupt handler comprises a System Control Interrupt (SCI) interrupt handler and wherein the SCI interrupt handler has operating system (OS) privilege level access to memory and circuitry.

15. The process of claim 11, wherein a format of the first interrupt comprises: System Control Interrupt (SCI), System Management Interrupt (SMI), or Non-Maskable Interrupt (NMI).

16. At least one non-transitory computer-readable medium comprising instructions stored thereon, that when executed by one or more processors, cause the one or more processors to:
execute a first interrupt handler that is to process a first interrupt, wherein the first interrupt is a translation of a second interrupt from System Management Interrupt (SMI) format to System Control Interrupt (SCI) format and
execute a second interrupt handler that is to process a third interrupt, wherein the third interrupt comprises a version of a source interrupt.

17. The non-transitory computer-readable medium of claim 16, wherein the first interrupt handler is to execute on a single thread.

18. The non-transitory computer-readable medium of claim 16, wherein the first interrupt handler comprises an SCI interrupt handler and has operating system (OS) privilege level access to memory and circuitry.

19. The non-transitory computer-readable medium of claim 16, wherein the translation of the first interrupt is based on a configuration.

20. The non-transitory computer-readable medium of claim 16, wherein the third interrupt comprises a format of: SCI, SMI, or Non-Maskable Interrupt (NMI).
